(19) United States
(12) Patent Application Publication
(10) Pub. No.: US 2026/0124767 A1
(43) Pub. Date: May 7, 2026

(54) CONTROL APPARATUS AND CONTROL METHOD

(71) Applicant: SONY GROUP CORPORATION, Tokyo (JP)

(72) Inventor: Hiroshi MIYAGAWA, Tokyo (JP)

(21) Appl. No.: 19/115,772

(22) PCT Filed: Aug. 9, 2023
(86) PCT No.: PCT/JP2023/029080

§ 371 Date: Mar. 26, 2025

(30) Foreign Application Priority Data
Oct. 3, 2022 (JP) 2022-159633

(51) Int. Cl. B25J 13/08; B25J 5/00; B25J 9/16; B25J 19/02

(52) U.S. Cl. CPC B25J 13/089; B25J 5/007; B25J 9/1664; B25J 19/023

(57) ABSTRACT

To execute, at a higher speed, arithmetic processing related to operation of a manipulator that transports objects.

A control apparatus includes a storage unit that stores object arrangement condition information in which gripping positions of an object available when a manipulator grips the object are set in advance in correspondence with a type of object and a position where the object is arranged, and a gripping position determination unit that determines, when the manipulator transports the object from a transport source position to a transport destination position, a gripping position of the object by the manipulator on the basis of basis of gripping positions of the object set in the object arrangement condition information for the transport source position and gripping positions of the object set in the object arrangement condition information for the transport destination position.

### TECHNICAL FIELD

The present disclosure relates to a control apparatus and a control method.

### BACKGROUND ART

In recent years, in various industrial fields such as product assembly lines and logistics systems, it has become common to transport objects using manipulators having a plurality of degrees of freedom.

For example, Patent Document 1 below discloses a technique for gripping loosely packed parts with a manipulator, regrasping the parts on a temporary placement stand, and aligning the parts on a pallet. With the technique disclosed in Patent Document 1, it is possible to generate in advance graspable postures of parts and stable postures on the temporary placement stand, and it is possible to reduce a burden on programming of the manipulator.

### CITATION LIST

### Patent Document

Patent Document 1: Japanese Patent Application Laid-Open No. 2015-44274

### SUMMARY OF THE INVENTION

### Problems to be Solved by the Invention

Generally, in order to operate a manipulator, a trajectory plan of a hand provided at a distal end of the manipulator is generated. In a case where an object is transported using a manipulator, therefore, it is important to consider positions and postures of the manipulator at which the object is gripped at a transport source position and a transport destination position. In manipulators that transport objects, therefore, calculation loads required to generate trajectory plans increase and calculation time becomes long as compared with manipulators other than those used to transport objects.

The present disclosure, therefore, proposes a novel and improved control apparatus and control method capable of executing arithmetic processing related to operation of a manipulator that transports objects at a higher speed.

### Solutions to Problems

According to the present disclosure, a control apparatus including a storage unit that stores object arrangement condition information in which gripping positions of an object available when a manipulator grips the object are set in advance in correspondence with a type of object and a position where the object is arranged, and a gripping position determination unit that determines, when the manipulator transports the object from a transport source position to a transport destination position, a gripping position of the object by the manipulator on the basis of basis of gripping positions of the object set in the object arrangement condition information for the transport source position and gripping positions of the object set in the object arrangement condition information for the transport destination position is provided.

In addition, according to the present disclosure, a control method including, by an arithmetic processing device, preparing object arrangement condition information in which gripping positions of an object available when a manipulator grips the object are set in advance in correspondence with a type of object and a position where the object is arranged, and determining, when the manipulator transports the object from a transport source position to a transport destination position, a gripping position of the object by the manipulator on the basis of gripping positions of the object set in the object arrangement condition information for the transport source position and gripping positions of the object set in the object arrangement condition information for the transport destination position is provided.

### BRIEF DESCRIPTION OF DRAWINGS

FIG. 1 is a schematic diagram illustrating an outline of a manipulator apparatus according to a first embodiment of the present disclosure.

FIG. 2 is a block diagram illustrating functional configuration of a control apparatus that controls the manipulator apparatus according to the first embodiment of the present disclosure.

FIG. 3 is a schematic diagram illustrating an example of a transport environment of the manipulator apparatus.

FIG. 4 is a table illustrating an example of work instruction data in a transport environment illustrated in FIG. 3.

FIG. 5 is a table illustrating an example of gripping position information.

FIG. 6 is a schematic diagram stereoscopically illustrating gripping positions of ID: 0 and ID: X illustrated in FIG. 5 for an object that is a rectangular parallelepiped.

FIG. 7 is a table illustrating an example of object arrangement condition information according to the first embodiment.

FIG. 8 is a flowchart illustrating a flow of operation of a work execution unit according to the first embodiment.

FIG. 9 is a flowchart illustrating a flow of operation of a gripping position determination unit according to the first embodiment.

FIG. 10 is a schematic diagram illustrating an outline of a mobile object according to a second embodiment of the present disclosure.

FIG. 11 is a block diagram illustrating functional configuration of a control apparatus that controls the mobile object according to the second embodiment of the present disclosure.

FIG. 12 is a table illustrating an example of object arrangement condition information according to the second embodiment.

FIG. 13 is a schematic diagram illustrating an example of a transport operation of the mobile object according to the second embodiment.

FIG. 14 is a flowchart illustrating a flow of operation of the mobile object when executing work according to the second embodiment.

### MODE FOR CARRYING OUT THE INVENTION

Preferred embodiments of the present disclosure will be described in detail hereinafter with reference to the accompanying drawings. Note that, in the present specification and drawings, components having substantially the same functional configurations are given the same reference numerals, and redundant description thereof is omitted.

Note that the description will be given in the following order.
1. First Embodiment
1.1. Manipulator Apparatus
1.2. Control Apparatus
1.3. Operation Example
2. Second Embodiment
2.1. Mobile Object
2.2. Control Apparatus
2.3. Operation Example

### 1. First Embodiment

### (1.1. Manipulator Apparatus)

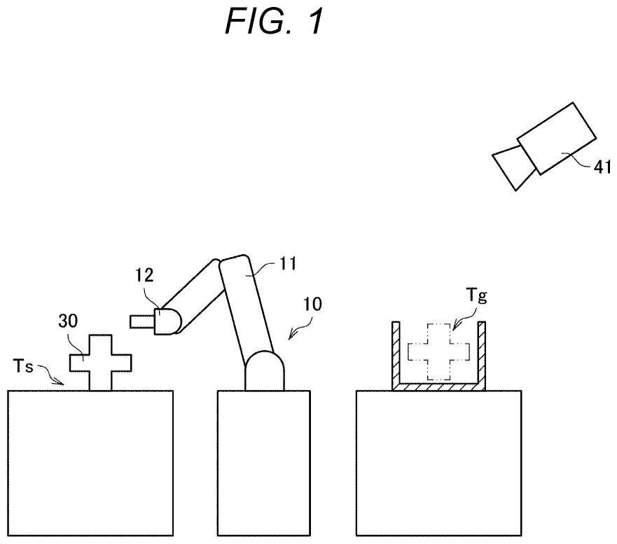

First, an outline of a manipulator apparatus according to a first embodiment of the present disclosure will be described with reference to FIG. 1. FIG. 1 is a schematic diagram illustrating an outline of a manipulator apparatus 10 according to the present embodiment.

As illustrated in FIG. 1, the manipulator apparatus 10 according to the present embodiment includes an arm portion 11 and a hand portion 12.

The arm portion 11 is an articulated robot arm having a plurality of links and a plurality of joints connecting the plurality of links to each other, and is attached on, for example, a fixed base. The hand portion 12 is an end effector capable of gripping an object 30, and is attached to a distal end of the arm portion 11. The hand portion 12 may be, for example, a hand including a plurality of fingers, a gripper including a plurality of claws, a suction hand that uses air or magnetic force, a hook having one of various shapes, or the like.

The manipulator apparatus 10 is a robot apparatus that moves (that is, transports) the object 30 arranged at a transport source position Ts to a transport destination position Tg. For example, the manipulator apparatus 10 can move the object 30 from the transport source position Ts to the transport destination position Tg by controlling operation of the arm portion 11 and the hand portion 12 on the basis of a captured image of the object 30 or a surrounding environment of the manipulator apparatus 10. The captured image of the object 30 or the surrounding environment of the manipulator apparatus 10 may be captured by an imaging device (not illustrated) mounted on the manipulator apparatus 10 or an imaging device 41 provided outside.

Furthermore, the manipulator apparatus 10 may control the operation of the arm portion 11 and the hand portion 12 further on the basis of depth information regarding the object 30 or the surrounding environment of the manipulator apparatus 10. The depth information regarding the object 30 or the surrounding environment of the manipulator apparatus 10 may be obtained by, for example, an imaging device such as a stereo camera, or may be obtained by a distance measuring sensor such as a time-of-flight (ToF) sensor or a light detection and ranging (LiDAR). These pieces of depth information may be obtained by a sensor, which is not illustrated, mounted on the manipulator apparatus 10 or a sensor (for example, the imaging device 41) provided outside.

### (1.2. Control Apparatus)

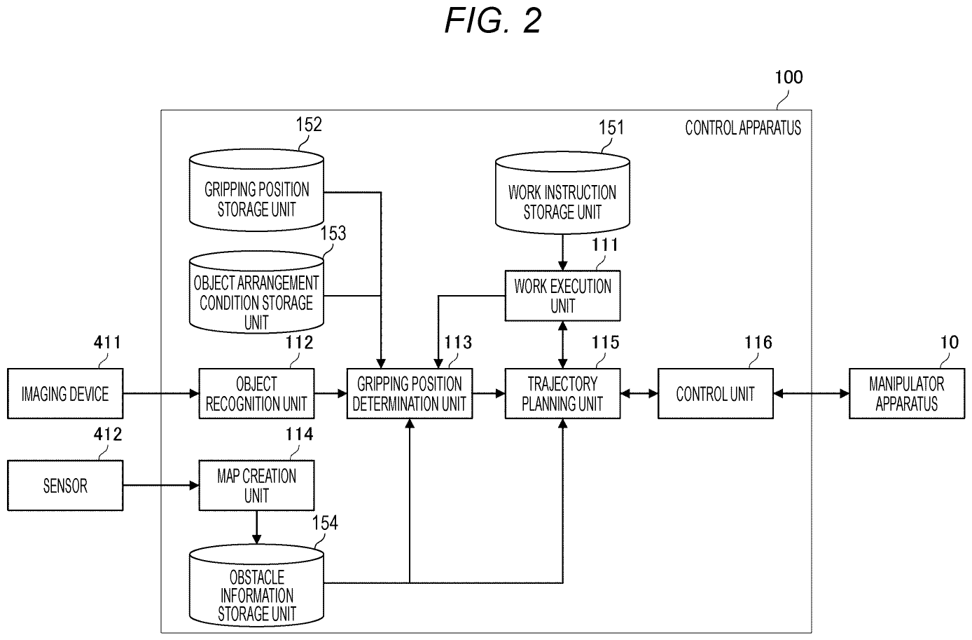

Next, a control apparatus 100 that controls the manipulator apparatus 10 according to the present embodiment will be described with reference to FIGS. 2 to 7. FIG. 2 is a block diagram illustrating functional configuration of the control apparatus 100 that controls the manipulator apparatus 10 according to the present embodiment.

As illustrated in FIG. 2, the control apparatus 100 includes an object recognition unit 112, a map creation unit 114, an obstacle information storage unit 154, a work execution unit 111, a work instruction storage unit 151, a gripping position determination unit 113, a gripping position storage unit 152, an object arrangement condition storage unit 153, a trajectory planning unit 115, and a control unit 116.

Note that each of steps of arithmetic processing performed by the control apparatus 100 can be achieved by cooperation of software and hardware including a central processing unit (CPU) that functions as an arithmetic processing device or a control apparatus, a read-only memory (ROM) that stores programs, arithmetic parameters, and the like used by the CPU, and a random-access memory (RAM) into which the programs are loaded in execution by the CPU. Furthermore, each storage unit of the control apparatus 100 may include a magnetic storage device such as a hard disk drive (HDD), a semiconductor storage device, an optical storage device, a magneto-optical storage device, or the like.

The object recognition unit 112 recognizes a type of object 30 and a three-dimensional position and posture of the object 30 on the basis of the captured image of the object 30 obtained by the imaging device 411. In an example, the object recognition unit 112 may recognize the type of object 30 and the three-dimensional position and posture of the object 30 by recognizing feature points of the object 30 from the captured image obtained by the imaging device 411. In another example, the object recognition unit 112 may recognize the type of object 30 and the three-dimensional position and posture of the object 30 by recognizing the captured image obtained by the imaging device 411 through machine learning.

The imaging device 411 is an RGB camera or a monochrome camera that captures an image of the object 30 or the surrounding environment of the manipulator apparatus 10. The imaging device 411 may be, for example, the imaging device 41 provided outside the manipulator apparatus 10 as illustrated in FIG. 1, or may be an imaging device, which is not illustrated, mounted on the manipulator apparatus 10.

The map creation unit 114 creates an obstacle map indicating positions of obstacles existing in the surrounding environment of the manipulator apparatus 10 on the basis of a result of sensing of the surrounding environment of the manipulator apparatus 10 obtained by a sensor 412 and a position where the sensor 412 is mounted. For example, the map creation unit 114 may create, as the obstacle map, an occupancy grid map for evaluating presence of obstacles with posterior probabilities.

The sensor 412 is a distance measuring sensor or a depth sensor capable of detecting an obstacle existing in the surrounding environment of the manipulator apparatus 10. The sensor 412 may be, for example, a distance measuring sensor such as a ToF sensor or a LiDAR (not illustrated) mounted on the manipulator apparatus 10, or may be a depth sensor of a depth camera or a stereo camera capable of obtaining a depth image. Note that the function of the sensor 412 may be incorporated into the imaging device 41 provided outside the manipulator apparatus 10 as illustrated in FIG. 1.

The obstacle map created by the map creation unit 114 is stored in, for example, the obstacle information storage unit 154. As a result, the map creation unit 114 can detect a new obstacle by extracting a difference between the known obstacle map stored in the obstacle information storage unit 154 and a newly created obstacle map. In addition, the obstacle information storage unit 154 may store an obstacle map in advance similarly to gripping position information and object arrangement condition information described later. At this time, the obstacle map stored in the obstacle information storage unit 154 may be an obstacle map created on the basis of environment information used when the object arrangement condition information is generated.

The work instruction storage unit 151 stores work instruction data indicating work that the manipulator apparatus 10 is to be caused to execute. The work instruction data may be separately input to the control apparatus 100 from the outside.

The work execution unit 111 instructs the manipulator apparatus 10 to perform operation control on the basis of work sequences defined in the work instruction data, and manages progress of each work sequence. Specifically, the work execution unit 111 may output, to the gripping position determination unit 113 and the trajectory planning unit 115, an instruction for causing the manipulator apparatus 10 to sequentially execute the work sequences defined in the work instruction data.

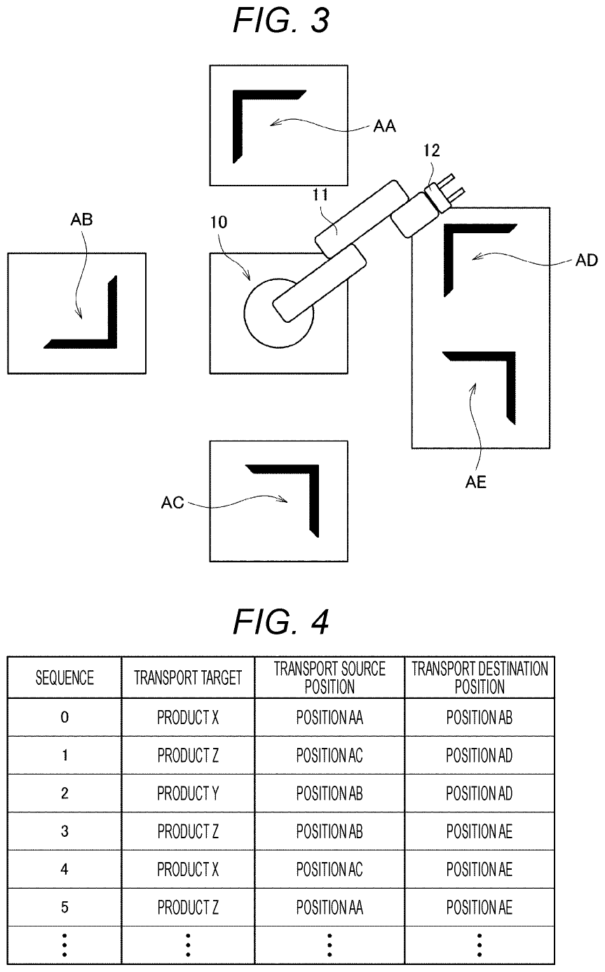

Content of the work instruction data will be described more specifically with reference to FIGS. 3 and 4. FIG. 3 is a schematic diagram illustrating an example of a transport environment of the manipulator apparatus 10. FIG. 4 is a table illustrating an example of work instruction data in the transport environment illustrated in FIG. 3.

As illustrated in FIG. 3, for example, it is assumed that positions AA to AE at which an object 30 can be arranged are provided around the manipulator apparatus 10. At this time, as illustrated in FIG. 4, in the work instruction data, the type (transport target) of an object 30 to be transported, the transport source position of the object 30, and the transport destination position of the object 30 are defined for each work sequence.

In the work instruction data illustrated in FIG. 4, for example, it is defined as sequence 0 that an object 30 of “product X” is transported from position AA as the transport source position to position AB as the transport destination position. In addition, in the work instruction data, it is defined as sequence 1 that an object 30 of “product Z” is transported from position AC as the transport source position to position AD as the transport destination position. Moreover, in the work instruction data, it is defined as sequence 2 that an object 30 of “product Y” is transported from position AB as the transport source position to position AD as the transport destination position. The type of object 30 to be transported in each of the other sequences, the transport source position of the object 30, and the transport destination position of the object 30 are similarly defined in the work instruction data.

The work execution unit 111 can continuously transport the various objects 30 by outputting an instruction to cause the manipulator apparatus 10 to execute the work sequences defined in the work instruction data in order from sequence 0.

The gripping position storage unit 152 stores, for each type of object 30 to be transported, gripping position information indicating a position at which the hand portion 12 grips the object 30. The gripping position information is information indicating, for each type of object 30, a position on the object 30 at which the object 30 can be gripped as a position and a posture relative to an origin of the object (for example, the center of a rectangular parallelepiped circumscribing the object 30). In the gripping position information, for example, one gripping position or a plurality of gripping positions may be indicated for each type of object 30.

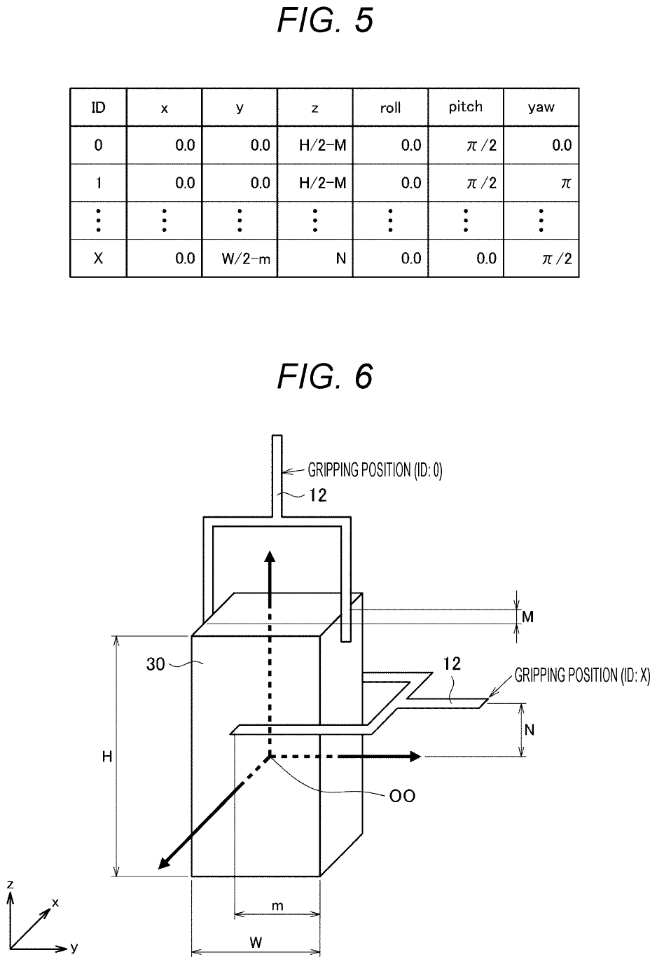

Content of the gripping position information will be described more specifically with reference to FIGS. 5 and 6. FIG. 5 is a table illustrating an example of the gripping position information according to the first embodiment. FIG. 6 is a schematic diagram stereoscopically illustrating gripping positions of ID: 0 and ID: X illustrated in FIG. 5 for an object 30 that is a rectangular parallelepiped.

As illustrated in FIG. 5, for example, the gripping position information includes information indicating, for each type of object 30, a position and a posture of gripping by one or more (X in FIG. 5) hand portions 12. Note that in the gripping position information illustrated in FIG. 5, the postures of the hand portions 12 are expressed with reference to a direction parallel to an xy plane of FIG. 6 and directed to a positive direction of an x-axis.

As illustrated in FIG. 6, at the gripping position of ID: 0, the hand portion 12 can grip the object 30 with an offset of 0 in an x-axis direction and a y-axis direction and an offset of H/2−M in a z-axis direction with the center of gravity of the object 30 as an origin 00. Note that the posture of the hand portion 12 at this time is a posture of zero rotations in a roll direction and a yaw direction and π/2 rotations in a pitch direction. H is height of the object 30 in the z-axis direction, and M is a margin from a gripping center of the hand portion 12 at the gripping position of ID: 0 to an end surface of the object 30.

Furthermore, at the gripping position of ID: X, the hand portion 12 can grip the object 30 with an offset of 0 in the x-axis direction, an offset of W/2−m in the y-axis direction, and an offset of N in the z-axis direction with the center of gravity of the object 30 as the origin OO. Note that the posture of the hand portion 12 at this time is a posture of zero rotations in the roll direction and the pitch direction and π/2 rotations in the yaw direction. W is width of the object 30 in the y-axis direction, N is an offset in the z-axis direction from the origin OO to the gripping position, and m is a margin from the gripping center of the hand portion 12 at the gripping position of ID: X to an end surface of the object 30.

In an example, the gripping position information may be obtained when a user arbitrarily moves the hand portion 12 with respect to a shape of the object 30 in real space or virtual space. Alternatively, in another example, the gripping position information may be automatically obtained from a captured image of the object 30, a depth image, or computer-aided design (CAD) information given in advance using a known algorithm for automatically extracting the position and posture of gripping by the hand portion 12 on the basis of the shape of the object 30.

The object arrangement condition storage unit 153 stores an object arrangement condition indicating a gripping position by the hand portion 12 capable of gripping the object 30 arranged at each position. The object arrangement condition information is information indicating, for each position in a space where the manipulator apparatus 10 works and for each type of object 30, available gripping positions for the object 30 arranged at the position.

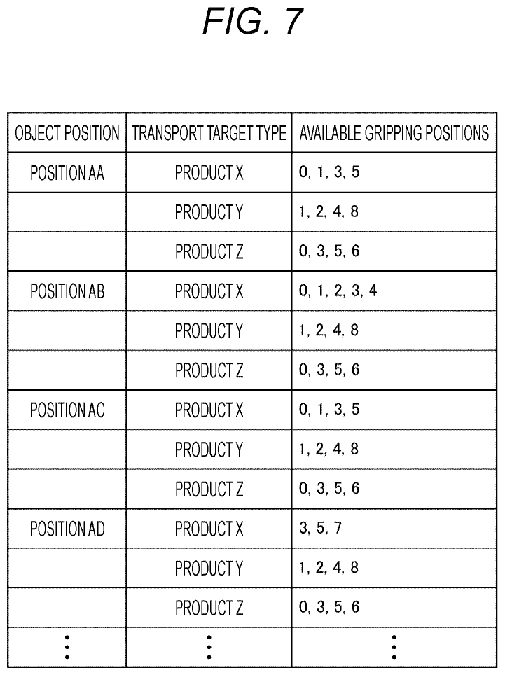

Content of the object arrangement condition information will be described more specifically with reference to FIG. 7. FIG. 7 is a table illustrating an example of the object arrangement condition information according to the first embodiment.

As illustrated in FIG. 7, for example, in the object arrangement condition information, gripping positions available to the hand portion 12 are set for each arrangement position of the object 30 and each type of object 30 arranged. The available gripping positions are gripping positions at which the hand portion 12 can grip the object 30 without interfering with the surrounding environment of the object 30 at a position where the object 30 is arranged. For example, the available gripping positions are gripping positions obtained by excluding gripping positions at which the hand portion 22 interferes with the surrounding environment of the object 30 at the position where the object 30 is arranged from gripping positions on the object 30 by the hand portion 22 indicated by the gripping position information.

For example, it is assumed that there are eight available gripping positions of ID: 0 to 7 for the object 30 of “product X”. The object arrangement condition information illustrated in FIG. 7 indicates that four gripping positions of ID: 0, 1, 3, and 5 are available at position AA, five gripping positions of ID: 0, 1, 2, 3, and 4 are available at position AB, four gripping positions of ID: 0, 1, 3, and 5 are available at position AC, and three gripping positions of ID: 3, 5, and 7 are available at position AD.

In addition, it is assumed that there are nine available gripping positions of ID: 0 to 8 for the object 30 of “product Y”. The object arrangement condition information illustrated in FIG. 7 indicates that four gripping positions of ID: 1, 2, 4, and 8 are available at position AA, four gripping positions of ID: 1, 2, 4, and 8 are available at position AB, four gripping positions of ID: 1, 2, 4, and 8 are available at position AC, and four gripping positions of ID: 1, 2, 4, and 8 are available at position AD.

Moreover, it is assumed that there are seven available gripping positions of ID: 0 to 6 for the object 30 of “product Z”. The object arrangement condition information illustrated in FIG. 7 indicates that four gripping positions of ID: 0, 3, 5, and 6 are available at position AA, four gripping positions of ID: 0, 3, 5, and 6 are available at position AB, four gripping positions of ID: 0, 3, 5, and 6 are available at position AC, and four gripping positions of ID: 0, 3, 5, and 6 are available at position AD.

The object arrangement condition information may be defined by the user in advance. Alternatively, the object arrangement condition information may be generated by determining interference between the hand portion 12 and an obstacle on the basis of a result of sensing performed by the sensor 412 on obstacles at various positions.

The gripping position determination unit 113 determines a gripping position of the object 30 by the hand portion 12 on the basis of the type of object 30, the transport source position, and the transport destination position included in a work sequence specified by the work execution unit 111.

Specifically, first, the gripping position determination unit 113 refers to the object arrangement condition information for the type of object 30 included in the work sequence, and determines gripping positions available at both the transport source position and the transport destination position as gripping position candidates for the hand portion 12. Subsequently, the gripping position determination unit 113 may determine, as the gripping position of the object 30 by the hand portion 12, a gripping position candidate with which the trajectory planning unit 115 at a subsequent stage has successfully generated a trajectory plan among the gripping position candidates for the hand portion 12.

Here, in a case where there is a plurality of gripping position candidates, the gripping position determination unit 113 may generate a candidate list in which the gripping position candidates are arranged in descending order of a score derived on the basis of the amount of change of the arm portion 11 and the hand portion 12 from the transport source position to the transport destination position. As a result, the trajectory planning unit 115 can generate a trajectory plan of the hand portion 12 using the gripping position candidate having the best score by generating trajectory plans using the gripping position candidates in order of arrangement in the candidate list. The gripping position determination unit 113 may delete, from the candidate list, gripping position candidates with which generation of a trajectory plan has failed in the trajectory planning unit 115 at the subsequent stage.

For example, the sum of squares of amounts of movement of the joints of the arm portion 11 when the hand portion 12 is moved from the transport source position to the transport destination position may be used as the score used when the candidate list is generated. In addition, a distance of the hand portion 12 from the transport source position to the transport destination position in a three-dimensional space or the amount of change of a three-dimensional posture may be used as the score used when the candidate list is generated. The lower the scores, the better.

Note that the gripping position determination unit 113 may determine whether or not positions and postures of the arm portion 11 and the hand portion 12 determined from each gripping position candidate interfere with an obstacle existing in the surrounding environment of the object 30. For example, the gripping position determination unit 113 may determine whether or not the positions and postures of the arm portion 11 and the hand portion 12 determined from each gripping position candidate interfere with an obstacle indicated on the obstacle map stored in the obstacle information storage unit 154. Alternatively, the gripping position determination unit 113 may determine whether or not the positions and postures of the arm portion 11 and the hand portion 12 determined from each gripping position candidate interfere with an obstacle recognized from an image captured by the imaging device 411. When the positions and postures of the arm portion 11 and the hand portion 12 determined from each gripping position candidate interfere with an obstacle existing in the surrounding environment of the object 30, the gripping position determination unit 113 may delete the gripping position candidate from the candidate list.

The trajectory planning unit 115 generates a trajectory plan of the entirety of the manipulator apparatus 10 that performs specified work on the basis of an instruction from the work execution unit 111, and outputs the generated trajectory plan to the control unit 116. Specifically, the trajectory planning unit 115 may generate a trajectory plan until the hand portion 12 moves from a current position to the gripping position candidate of the object 30 arranged at the transport source position, and a trajectory plan until the hand portion 12 moves from the gripping position candidate of the object 30 arranged at the transport source position to the gripping position candidate of the object 30 arranged at the transport destination position.

The trajectory planning unit 115 may generate a trajectory plan of the manipulator apparatus 10 using a gripping position candidate having the best score in the candidate list generated by the gripping position determination unit 113. In a case where the generation of the trajectory plan of the hand portion 12 fails, the trajectory planning unit 115 may generate the trajectory plan of the hand portion 12 using a gripping position candidate having the next highest score as described above.

If the trajectory plan of the manipulator apparatus 10 is successfully generated, the trajectory planning unit 115 transmits the generated trajectory plan and the used gripping position by the hand portion 12 to the work execution unit 111. Thereafter, by receiving an instruction to execute a transport operation from the work execution unit 111, the trajectory planning unit 115 transmits the generated trajectory plan of the manipulator apparatus 10 and the used gripping position by the hand portion 12 to the control unit 116.

The control unit 116 controls driving of motors for rotating the joints of the arm portion 11 such that the hand portion 12 operates in accordance with the trajectory plan received from the trajectory planning unit 115. When the transport of the object 30 is completed, the control unit 116 notifies the work execution unit 111 of the completion of the transport work via the trajectory planning unit 115. As a result, the work execution unit 111 can advance the work sequence defined in the work instruction data to a next sequence.

With the above configuration, in the transport of the object 30 by the manipulator apparatus 10, the control apparatus 100 can use the same gripping position of the object 30 at the transport source position and the transport destination position, and the transport of the object 30 becomes more likely to be successful. In addition, the control apparatus 100 can reduce the amount of calculation for the transport by deriving in advance gripping positions available when gripping the object 30 at one of various positions. Therefore, the control apparatus 100 can further speed up arithmetic processing for the transfer.

In the control apparatus 100, the gripping positions of the object 30 are limited in advance in the gripping position information, and then the gripping positions of the object 30 are further limited in accordance with the position arrangement of the object 30 in the object arrangement condition information. Therefore, in the control apparatus 100, the gripping positions of the object 30 available at the transport source position or the transport destination position are not continuously examined, but are limited to a plurality of types. When the same gripping position of the object 30 is used at the transport source position and the transport destination position, therefore, the control apparatus 100 can ensure that such a gripping position of the object 30 certainly exists. In addition, the control apparatus 100 can specify the same gripping position of the object 30 at the transport source position and the transport destination position at a lower calculation cost by comparing the gripping positions of the object 30 available at the transport source position and the gripping positions of the object 30 available at the transport destination position.

Moreover, even in a case where a new obstacle appears, the control apparatus 100 only needs to determine whether gripping positions available when the object 30 is gripped and the new obstacle interfere with each other, and it is possible to execute, at high speed, arithmetic processing for avoiding the new obstacle.

### (1.3. Operation Example)

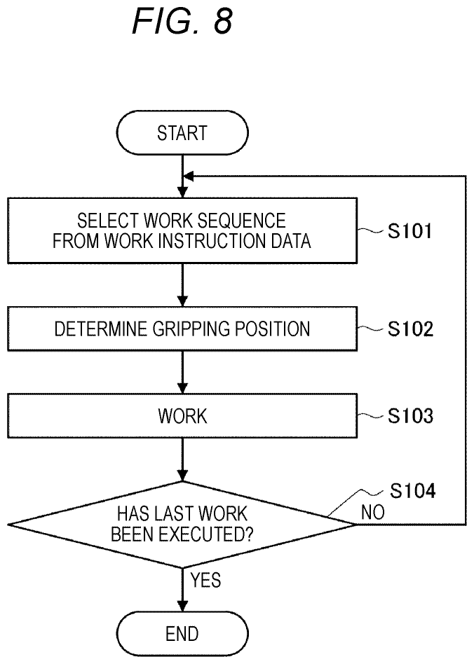

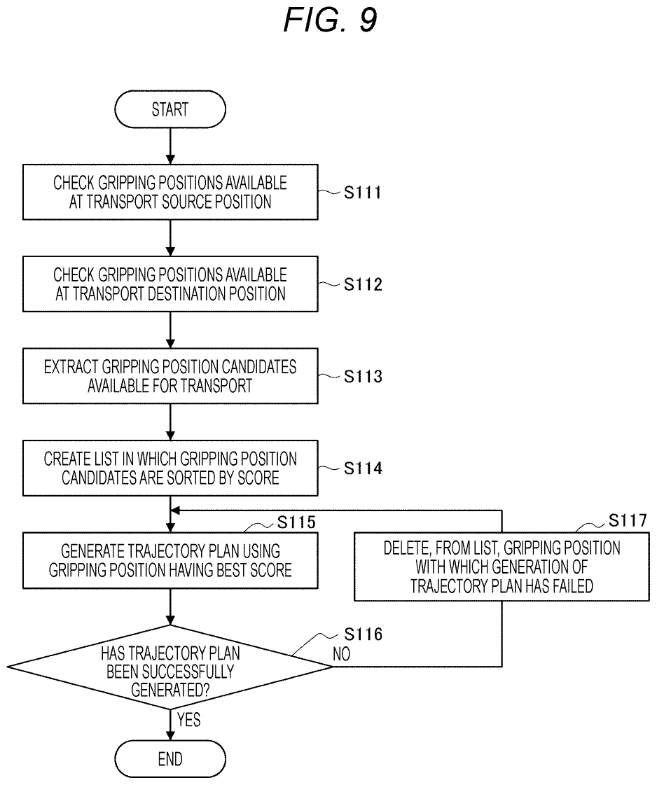

Next, an example of operation of the control apparatus 100 that controls the manipulator apparatus 10 according to the present embodiment will be described with reference to FIGS. 8 and 9. FIG. 8 is a flowchart illustrating a flow of operation of the work execution unit 111. FIG. 9 is a flowchart illustrating a flow of operation of the gripping position determination unit 113.

As illustrated in FIG. 8, first, the work execution unit 111 selects a work sequence to be executed from the work instruction data stored in the work instruction storage unit 151 (S101). For example, in the work instruction data illustrated in FIG. 4, a work sequence specifying the type of the object 30 to be transported, the transport source position, and the transport destination position is defined in each row. The work execution unit 111 extracts a work sequence to be executed from the work instruction data, and transmits the extracted work sequence to the gripping position determination unit 113. A case where work of sequence 0 in the work instruction data illustrated in FIG. 4 is executed will be described hereinafter as an example.

Next, the gripping position determination unit 113 determines the gripping position of the object 30 by the hand portion 12 on the basis of the work sequence received from the work execution unit 111 (S102).

Specifically, as illustrated in FIG. 9, the gripping position determination unit 113 first checks the gripping positions by the hand portion 12 available at the transport source position on the basis of the object arrangement condition information (S111). For example, in the object arrangement condition information illustrated in FIG. 7, in a case where the object 30 of “product X” is arranged at position AA as the transport source position, the available gripping positions are ID: 0, 1, 3, and 5.

Note that the gripping position determination unit 113 may further limit the available gripping positions by determining interference between the positions and postures of the arm portion 11 and the hand portion 12 at the available gripping positions obtained from the object arrangement condition information and obstacles existing in the surrounding environment of the object 30. As the obstacles existing in the surrounding environment of the object 30, for example, obstacles existing in the obstacle map stored in the obstacle information storage unit 154 may be used, or obstacles recognized in an image captured by the imaging device 411 or a result of sensing performed by the sensor 412 may be used. Alternatively, the gripping position determination unit 113 may determine interference only with respect to a new obstacle, which is a difference between the obstacle map created by the map creation unit 114 and the obstacle map stored in advance.

Next, the gripping position determination unit 113 checks the gripping positions by the hand portion 12 available at the transport destination position on the basis of the object arrangement condition information (S112). For example, in the object arrangement condition information illustrated in FIG. 7, in a case where the object 30 of “product X” is arranged at position AB as the transport destination position, the available gripping positions are ID: 0, 1, 2, 3, and 4. Note that, as in the case of the transport source position, the gripping position determination unit 113 may further limit the available gripping positions by determining interference between the positions and postures of the arm portion 11 and the hand portion 12 at the available gripping positions and the obstacles existing in the surrounding environment of the object 30. At this time, the gripping position determination unit 113 may determine interference only with respect to a new obstacle, which is a difference between the obstacle map created by the map creation unit 114 and the obstacle map stored in advance.

Subsequently, the gripping position determination unit 113 extracts the gripping positions by the hand portion 12 available at both the transport source position and the transport destination position as gripping position candidates available for the transport (S113). This is because the hand portion 12 keeps gripping the object 30 at the same gripping position in order to transport the object 30 from the transport source position to the transport destination position. In the object arrangement condition information illustrated in FIG. 7, since the gripping positions available at the transport source position are ID: 0, 1, 3, and 5 and the gripping positions available at the transport destination position are ID: 0, 1, 2, 3, and 4, ID: 0, 1, and 3 are extracted as the gripping position candidates available for the transport.

Next, the gripping position determination unit 113 creates a candidate list by sorting the extracted gripping position candidates by score (S114). As described above, the sum of squares of amounts of movement of the joints of the arm portion 11 when the hand portion 12 is moved from the transport source position to the transport destination position may be used as the score, or the distance of the hand portion 12 from the transport source position to the transport destination position in the three-dimensional space or the amount of change of the three-dimensional posture may be used.

Moreover, the gripping position determination unit 113 causes the trajectory planning unit 115 to generate a trajectory plan of the entirety of the manipulator apparatus 10 using the gripping position candidate having the best score in the generated candidate list (S115).

Note that before causing the trajectory planning unit 115 to generate the trajectory plan, the gripping position determination unit 113 may determine whether or not to generate the trajectory plan using the gripping position candidates by again determining interference between the positions and postures of the arm portion 11 and the hand portion 12 at the gripping position candidates and the obstacles. At this time, the gripping position determination unit 113 may determine interference only with respect to a new obstacle, which is a difference between the obstacle map created by the map creation unit 114 and the obstacle map stored in advance.

Subsequently, the gripping position determination unit 113 determines whether or not the trajectory plan has been successfully generated (S116). If the trajectory plan has been successfully generated (S116/Yes), the gripping position determination unit 113 can determine the gripping position candidate with which the trajectory plan has been successfully generated as the gripping position by the hand portion 12 to be used to transport the object 30.

If the generation of the trajectory plan fails due to interference with an obstacle, a movable range of the arm portion 11, or the like (S116/No), on the other hand, the gripping position determination unit 113 deletes, from the candidate list, the gripping position candidate with which the generation of the trajectory plan has failed (S117). Moreover, the gripping position determination unit 113 returns to the operation in step S115 and causes the trajectory planning unit 115 to generate the trajectory plan of the hand portion 12 again using a gripping position candidate having a next best score in the candidate list (S115).

Referring back to FIG. 8, the work execution unit 111 then transmits the generated trajectory plan of the hand portion 12 and the gripping position by the hand portion 12 from the trajectory planning unit 115 to the control unit 116 to cause the manipulator apparatus 10 to execute work of transporting the object 30 (S103).

Subsequently, when the work execution unit is notified of an end of the transport work from the control unit 116 via the trajectory planning unit 115, the work execution unit 111 determines whether or not a last work sequence defined in the work instruction data has been executed (S104). If the last work sequence has not been executed (S104/No), the work execution unit 111 returns to the operation in step S101, selects a next work sequence defined in the work instruction data, and causes the manipulator apparatus 10 to keep executing the transport work. If the last work sequence has been executed (S104/Yes), on the other hand, the work execution unit 111 ends the operation and the transport work by the manipulator apparatus 10.

With the above operation, the control apparatus 100 can cause the manipulator apparatus 10 to continuously transport the objects 30 on the basis of the work instruction data.

### 2. Second Embodiment

### (2.1. Mobile Object)

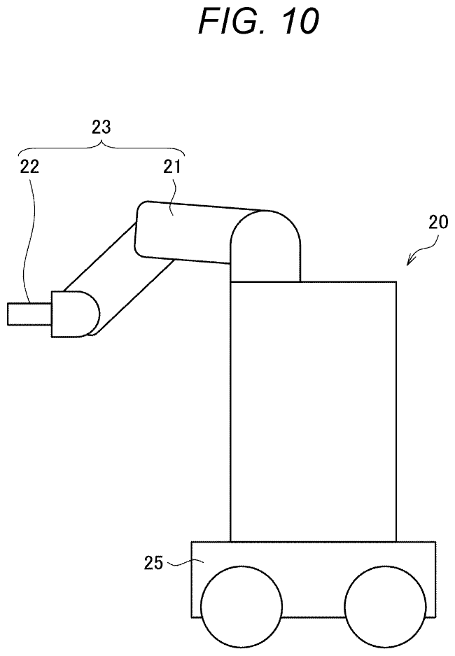

Next, an outline of a mobile object 20 according to a second embodiment of the present disclosure will be described with reference to FIG. 10. FIG. 10 is a schematic diagram illustrating the outline of the mobile object 20 according to the present embodiment.

As illustrated in FIG. 1, the mobile object 20 according to the present embodiment includes a manipulator 23 and a moving mechanism 25.

The manipulator 23 includes an arm portion 21 and a hand portion 22. The arm portion 11 is an articulated robot arm having a plurality of links and a plurality of joints connecting the plurality of links to each other, and is attached, for example, on a main body of the mobile object 20. The hand portion 22 is an end effector capable of gripping an object 30, and is attached to a distal end of the arm portion 11. The hand portion 22 may be, for example, a hand including a plurality of fingers, a gripper including a plurality of claws, a suction hand that uses air or magnetic force, or such as a hook having one of various shapes.

The moving mechanism 25 is a mechanism capable of moving the mobile object 20 to a desired place. The moving mechanism 25 may be, for example, any moving mechanism such as two or more wheels, two or more legs, a crawler, an air cushion, or a rotary blade. For example, the moving mechanism 25 may be a moving mechanism including four wheels.

The mobile object 20 is a robot apparatus that moves (that is, transports) an object 30 arranged at a transport source position to a transport destination position. Since the mobile object 20 can move itself with the moving mechanism 25, it is possible to transport the object 30 to a transport destination position more distant from a transport source position.

The mobile object 20 can grip the object 30 with the manipulator 23 on the basis of a captured image of or depth information regarding a surrounding environment of the object 30 and move with the moving mechanism 25 on the basis of a captured image of or the depth information regarding the surrounding environment of the mobile object 20. The captured image of the surrounding environment of the object 30 or the mobile object 20 may be obtained by an imaging device such as an RGB camera or a monochrome camera. The depth information regarding the surrounding environment of the object 30 or the mobile object 20 may be obtained by a stereo camera, a ToF sensor, a LIDAR, or the like.

### (2.2. Control Apparatus)

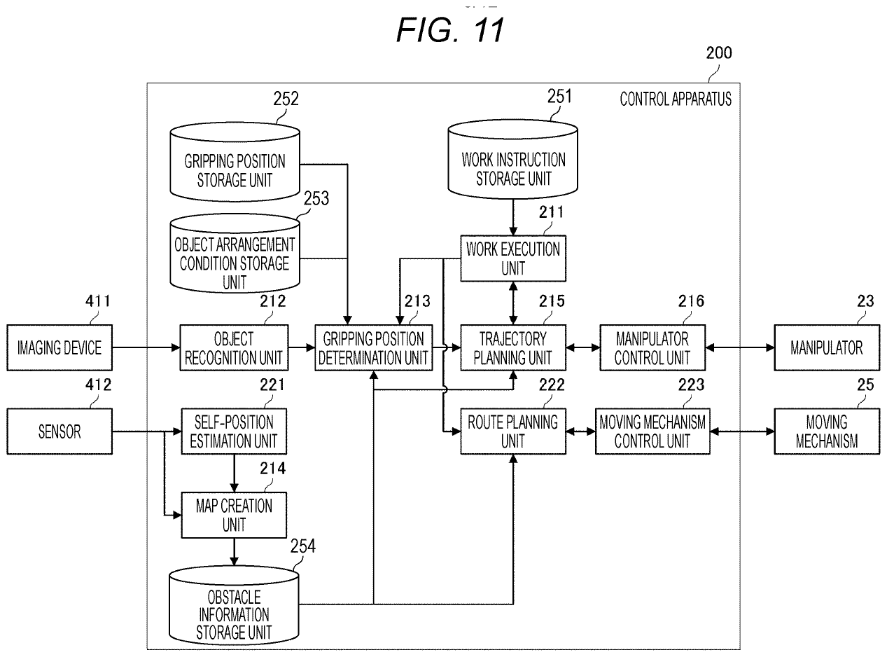

Next, a control apparatus 200 that controls the mobile object 20 according to the present embodiment will be described with reference to FIGS. 11 to 14. FIG. 11 is a block diagram illustrating functional configuration of the control apparatus 200 that controls the mobile object 20 according to the present embodiment.

As illustrated in FIG. 11, the control apparatus 200 includes an object recognition unit 212, a self-position estimation unit 221, a map creation unit 214, an obstacle information storage unit 254, a work execution unit 211, a work instruction storage unit 251, a gripping position determination unit 213, a gripping position storage unit 252, an object arrangement condition storage unit 253, a trajectory planning unit 215, a manipulator control unit 216, a route planning unit 222, and a moving mechanism control unit 223.

Note that each of steps of arithmetic processing performed by the control apparatus 200 can be achieved by cooperation of software and hardware including a CPU that functions as an arithmetic processing device or a control apparatus, a ROM that stores programs, arithmetic parameters, and the like used by the CPU, and a RAM into which the program are loaded in execution by the CPU. Furthermore, each storage unit of the control apparatus 100 may include a magnetic storage device such as an HDD, a semiconductor storage device, an optical storage device, a magneto-optical storage device, or the like.

The object recognition unit 212 recognizes a type of object 30 and a three-dimensional position and posture of the object 30 on the basis of a captured image of the object 30 obtained by an imaging device 411. In an example, the object recognition unit 212 may recognize the type of object 30 and the three-dimensional position and posture of the object 30 by recognizing feature points of the object 30 from the captured image obtained by the imaging device 411. In another example, the object recognition unit 212 may recognize the type of object 30 and the three-dimensional position and posture of the object 30 by recognizing the captured image obtained by the imaging device 411 through machine learning.

The imaging device 411 is an RGB camera or a monochrome camera that captures an image of the surrounding environment of the object 30 or the mobile object 20. The imaging device 411 may be mounted on, for example, the mobile object 20.

The self-position estimation unit 221 estimates a current position of the mobile object 20 on the basis of information regarding the surrounding environment of the mobile object 20 obtained by a sensor 412. The self-position estimation unit 221 may estimate the current position of the mobile object 20 on the basis of distance measurement information or depth information obtained by the sensor 412. Alternatively, the self-position estimation unit 221 may estimate the current position of the mobile object 20 on the basis of information obtained by an inertial measurement unit (IMU) mounted on the mobile object 20 or an encoder of the moving mechanism 25.

The map creation unit 214 creates an obstacle map indicating positions of obstacles existing in the surrounding environment of the mobile object 20 on the basis of a result of sensing of the surrounding environment of the mobile object 20 obtained by the sensor 412 and the current position of the mobile object 20 estimated by the self-position estimation unit 221. For example, the map creation unit 214 may create, as the obstacle map, an occupancy grid map for evaluating presence of obstacles with posterior probabilities.

The sensor 412 is a distance measuring sensor or a depth sensor capable of detecting obstacles existing in the surrounding environment of the mobile object 20. The sensor 412 may be, for example, a distance measuring sensor such as a ToF sensor or a LiDAR mounted on the mobile object 20, or may be a depth sensor of a depth camera or a stereo camera capable of obtaining a depth image.

The obstacle map created by the map creation unit 214 is stored in, for example, the obstacle information storage unit 254. As a result, the map creation unit 214 can detect a new obstacle by extracting a difference between the known obstacle map stored in the obstacle information storage unit 254 and a newly created obstacle map. In addition, the obstacle information storage unit 254 may store an obstacle map in advance similarly to gripping position information and object arrangement condition information described later. At this time, the obstacle map stored in the obstacle information storage unit 254 may be an obstacle map created on the basis of environment information used when the object arrangement condition information is generated.

The work instruction storage unit 251 stores work instruction data indicating work that the mobile object 20 is to be caused to execute. The work instruction data may be separately input to the control apparatus 200 from the outside.

The work execution unit 211 instructs the mobile object 20 to perform operation control on the basis of work sequences defined in the work instruction data, and manages progress of each work sequence. Specifically, the work execution unit 211 may output, to the gripping position determination unit 213, the trajectory planning unit 215, and the route planning unit 222, an instruction for causing the mobile object 20 to sequentially execute the work sequences defined in the work instruction data.

The work execution unit 211 can continuously transport the various objects 30 by outputting an instruction to cause the mobile object 20 to sequentially execute the work sequences defined in the work instruction data as illustrated in FIG. 4.

The gripping position storage unit 252 stores, for each type of object 30 to be transported, gripping position information indicating a position at which the hand portion 22 grips the object 30. The gripping position information is information indicating, for each type of object 30, a position on the object 30 at which the object 30 can be gripped as a position and a posture relative to an origin of the object (for example, the center of a rectangular parallelepiped circumscribing the object 30). In the gripping position information, for example, one gripping position or a plurality of gripping positions may be indicated for each type of object 30.

In an example, the gripping position information may be obtained when a user arbitrarily moves the hand portion 22 with respect to a shape of the object 30 in real space or virtual space. Alternatively, in another example, the gripping position information may be automatically obtained from a captured image of the object 30, a depth image, or CAD information using a known algorithm for automatically extracting the position and posture of gripping by the hand portion 22 on the basis of the shape of the object 30.

The object arrangement condition storage unit 253 stores an object arrangement condition indicating a gripping position by the hand portion 22 capable of gripping the object 30 arranged at each position. The object arrangement condition information is information indicating, for each position in a space where the mobile object 20 works and for each type of object 30, available gripping positions for the object 30 arranged at the position.

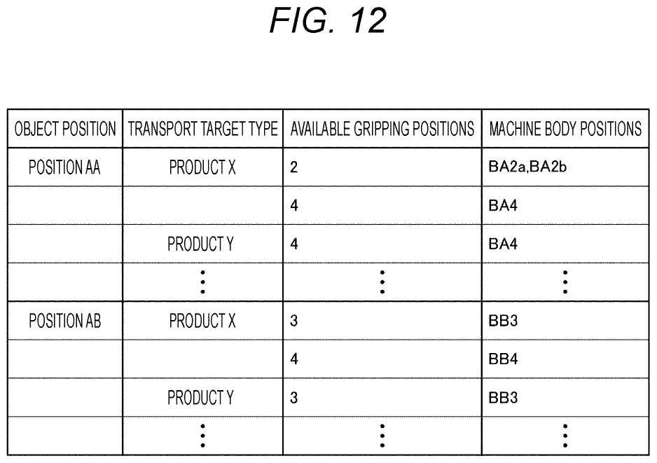

Content of the object arrangement condition information will be described more specifically with reference to FIG. 12. FIG. 12 is a table illustrating an example of the object arrangement condition information according to the second embodiment.

As illustrated in FIG. 12, for example, in the object arrangement condition information, gripping positions available to the hand portion 22 and machine body positions of the mobile object 20 are set for each arrangement position of the object 30 and each type of object 30 arranged.

The available gripping positions are gripping positions at which the hand portion 22 can grip the object 30 without interfering with the surrounding environment of the object 30 at a position where the object 30 is arranged. For example, the available gripping positions may be gripping positions obtained by excluding gripping positions at which the hand portion 22 interferes with the surrounding environment of the object 30 at the position where the object 30 is arranged from gripping positions on the object 30 by the hand portion 22 indicated by the gripping position information.

The machine body positions are positions of the mobile object 20 at which the hand portion 22 can reach the available gripping positions set for each arrangement position of the object 30 and each type of object 30 arranged. For example, the machine body positions may be positions at which the arm portion 21 and the mobile object 20 can be arranged without interfering with an obstacle or the like in addition to the hand portion 22 being able to reach the available gripping positions.

For example, it is assumed that there are five available gripping positions of ID: 0 to 4 for the object 30 of “product X”. The object arrangement condition information illustrated in FIG. 12 indicates, for the object 30 of “product X”, that gripping positions of ID: 2 and 4 are available at position AA, the machine body positions of the mobile object 20 at the gripping position of ID: 2 are BA2a and BA2b, and the machine body position of the mobile object 20 at the gripping position of ID: 4 is BA4. In addition, it is indicated for the object 30 of “product X” that gripping positions of ID: 3and 4 are available at position AB, the machine body position of the mobile object 20 at the gripping position of ID: 3 is BB3, and the machine body position of the mobile object 20 at the gripping position of ID: 4 is BB4.

It is assumed, for the object 30 of “product Y”, on the other hand, that there are five available gripping positions of ID: 0 to 4. The object arrangement condition information illustrated in FIG. 12 indicates, for the object 30 of “product Y”, that the gripping position of ID: 4 is available at position AA, and the machine body position of the mobile object 20 at the gripping position of ID: 4 is BA4. In addition, it is indicated for the object 30 of “product Y” that the gripping position of ID: 3 is available at position AB, and the machine body position of the mobile object 20 at the gripping position of ID: 3 is BB3.

The object arrangement condition information may be defined by the user in advance. Alternatively, the object arrangement condition information may be generated by determining interference between the hand portion 22, the arm portion 21, and a main body of the mobile object 20 and an obstacle on the basis of a result of sensing of the obstacle performed by the sensor 412 at each position.

The gripping position determination unit 213 determines a gripping position of the object 30 by the hand portion 22 on the basis of the type of object 30, the transport source position, and the transport destination position included in a work sequence specified by the work execution unit 211.

Specifically, first, the gripping position determination unit 213 refers to the object arrangement condition information for the type of object 30 included in the work sequence, and determines gripping positions available at both the transport source position and the transport destination position as gripping position candidates for the hand portion 22. Subsequently, the gripping position determination unit 213 may determine, among the gripping position candidates for the hand portion 22, a gripping position candidate with which the trajectory planning unit 215 and the route planning unit 222 at subsequent stages have successfully generated a trajectory plan and a route plan as the gripping position of the object 30 by the hand portion 22.

Here, in a case where there is a plurality of gripping position candidates, the gripping position determination unit 213 may generate a candidate list in which the gripping position candidates are arranged in descending order of a score derived on the basis of the amount of change of the manipulator 23 from the transport source position to the transport destination position. As a result, the trajectory planning unit 215 and the route planning unit 222 can generate a trajectory plan of the hand portion 22 and a route plan of the mobile object 20 using the gripping position candidate having the best score by generating trajectory plans and route plans using the gripping position candidates in order of arrangement in the candidate list. The gripping position determination unit 213 may delete, from the candidate list, gripping position candidates with which generation of a trajectory plan or a route plan has failed in the trajectory planning unit 215 or the route planning unit 222 at the subsequent stages.

For example, the sum of squares of amounts of movement of the joints of the arm portion 11 when the hand portion 22 is moved from the transport source position to the transport destination position may be used as the score used when the candidate list is generated. In addition, a distance of the hand portion 22 from the transport source position to the transport destination position in a three-dimensional space or the amount of change of a three-dimensional posture may be used as the score used when the candidate list is generated. Moreover, a straight line distance from the machine body position of the transport source position to the machine body position of the transport destination position may be used as the score used when the candidate list is generated. The lower the scores, the better.

Note that the gripping position determination unit 213 may determine whether or not positions and postures of the manipulator 23 and the mobile object 20 determined from each gripping position candidate interfere with an obstacle existing in the surrounding environment of the object 30. For example, the gripping position determination unit 213 may determine whether or not the positions and postures of the manipulator 23 and the mobile object 20 determined from each gripping position candidate interfere with an obstacle indicated on the obstacle map stored in the obstacle information storage unit 254. Furthermore, the gripping position determination unit 213 may determine whether or not the positions and postures of the manipulator 23 and the mobile object 20 determined from each gripping position candidate interfere with an obstacle recognized in an image captured by the imaging device 411. In a case where the positions and postures of the manipulator 23 and the mobile object 20 determined from each gripping position candidate interfere with an obstacle existing in the surrounding environment of the object 30, the gripping position determination unit 213 may delete the gripping position candidate from the candidate list.

The trajectory planning unit 215 generates, on the basis of an instruction from the work execution unit 211, a trajectory plan of the manipulator 23 that performs specified work, and outputs the generated trajectory plan to the manipulator control unit 216.

It is assumed, for example, that when the mobile object 20 moves, the manipulator 23 takes a specific transport posture that does not interfere with the moving mechanism 25. In such a case, the trajectory planning unit 215 may generate a trajectory plan in which the hand portion 22 reciprocates between a position of the hand portion 22 in the transport posture and each gripping position candidate of the object 30 arranged at the transport source position, and a trajectory plan in which the hand portion 22 reciprocates between a position of the hand portion 22 in the transport posture and each gripping position candidate of the object 30 arranged at the transport destination position. At this time, it is assumed that the mobile object 20 exists at a machine body position corresponding to the gripping position candidate.

The trajectory planning unit 215 may generate the trajectory plan of the manipulator 23 using the gripping position candidates in order of the score from the candidate list generated by the gripping position determination unit 213. In a case where there is a plurality of machine body positions corresponding to the gripping position candidates, in an example, the trajectory planning unit 215 may generate the trajectory plan of the manipulator 23 using the machine body position having the best set score. As the score at this time, a straight line distance from the machine body position corresponding to the transport source position to the machine body position corresponding to the transport destination position may be used. In another example, the trajectory planning unit 215 may generate trajectory plans of the manipulator 23 using all the machine body positions and select a trajectory plan in which a distance of a generated trajectory is the shortest.

If the trajectory plan of the manipulator 23 is successfully generated, the trajectory planning unit 215 transmits the generated trajectory plan and the used gripping position by the hand portion 22 to the work execution unit 211. Thereafter, by receiving an instruction to execute a transport operation from the work execution unit 211, the trajectory planning unit 215 transmits the generated trajectory plan and the used gripping position by the hand portion 22 to the manipulator control unit 216. If the generation of the trajectory plan of the hand portion 22 fails, on the other hand, the trajectory planning unit 215 may generate the trajectory plan of the manipulator 23 using a gripping position candidate having the next highest score.

The route planning unit 222 generates, on the basis of an instruction from the work execution unit 211, a route plan of the mobile object 20 that performs specified work, and outputs the generated route plan to the moving mechanism control unit 223. Specifically, the route planning unit 222 may generate, on the basis of the obstacle map generated by the map creation unit 214 and the self-position estimated by the self-position estimation unit 221, a route plan for reaching the position specified by the work execution unit 211 while avoiding obstacles. For example, the route planning unit 222 may generate a route plan from the current position of the mobile object 20 to a machine body position of the mobile object 20 corresponding to each gripping position candidate at the transport source position and a picture route plan from the machine body position of the mobile object 20 corresponding to the gripping position candidate at the transport source position to a machine body position of the mobile object 20 corresponding to each gripping position candidate at the transport destination position. Note that when the sensor 412 newly detects an obstacle and the obstacle map is updated, the route planning unit 222 may update the generated route plan.

For example, the route planning unit 222 may generate the trajectory plan of the mobile object 20 using a machine body position of the mobile object 20 corresponding to a gripping position candidate with which a trajectory of the manipulator 23 has been successfully planned. In a case where there is a plurality of machine body positions of the mobile object 20 corresponding to the gripping position candidates, in an example, the route planning unit 222 may generate a route plan of the mobile object 20 using a machine body position having the best set score. As the score at this time, a straight line distance from the machine body position corresponding to the transport source position to the machine body position corresponding to the transport destination position may be used. Alternatively, in another example, the route planning unit 222 may generate a route plan of the mobile object 20 using all the machine body positions, and select a route plan in which a distance of a generated route is the shortest.

If the route plan of the mobile object 20 is successfully generated, the route planning unit 222 transmits the generated route plan to the work execution unit 211. Thereafter, by receiving an instruction to execute a transport operation from the work execution unit 211, the route planning unit 222 transmits the generated route plan to the moving mechanism control unit 223. If the generation of the route plan of the mobile object 20 fails, on the other hand, the route planning unit 222 may discard the gripping position with which the generation of the route plan has failed, and request the trajectory planning unit 215 again to generate a trajectory plan of the manipulator 23 using another gripping position candidate.

The manipulator control unit 216 controls driving of motors that rotate the joints of the arm portion 11 such that the hand portion 22 operates in accordance with the trajectory plan received from the trajectory planning unit 215. The moving mechanism control unit 223 controls driving of the moving mechanism 25 such that the mobile object 20 moves in accordance with the route plan received from the route planning unit 222 from the current position estimated by the self-position estimation unit 221.

In a case where the transport of the object 30 is completed, the manipulator control unit 216 and the moving mechanism control unit 223 notify the work execution unit 211 of the completion of the transport work. As a result, the work execution unit 211 can advance the work sequence defined in the work instruction data to a next sequence.

With the above configuration, in the transport of the object 30 by the manipulator 23 of the mobile object 20, the control apparatus 200 can use the same gripping position of the object 30 at the transport source position and the transport destination position, and the transport of the object 30 becomes more likely to be successful. In addition, the control apparatus 200 can reduce the amount of calculation for the transport by deriving in advance gripping positions available when gripping the object 30 at one of various positions. Therefore, the control apparatus 200 can further speed up arithmetic processing for the transfer.

Moreover, even in a case where a new obstacle appears, the control apparatus 200 only needs to determine whether gripping positions available when the object 30 is gripped and the new obstacle interfere with each other, and it is possible to execute, at high speed, arithmetic processing for avoiding the new obstacle.

### (2.3. Operation Example)

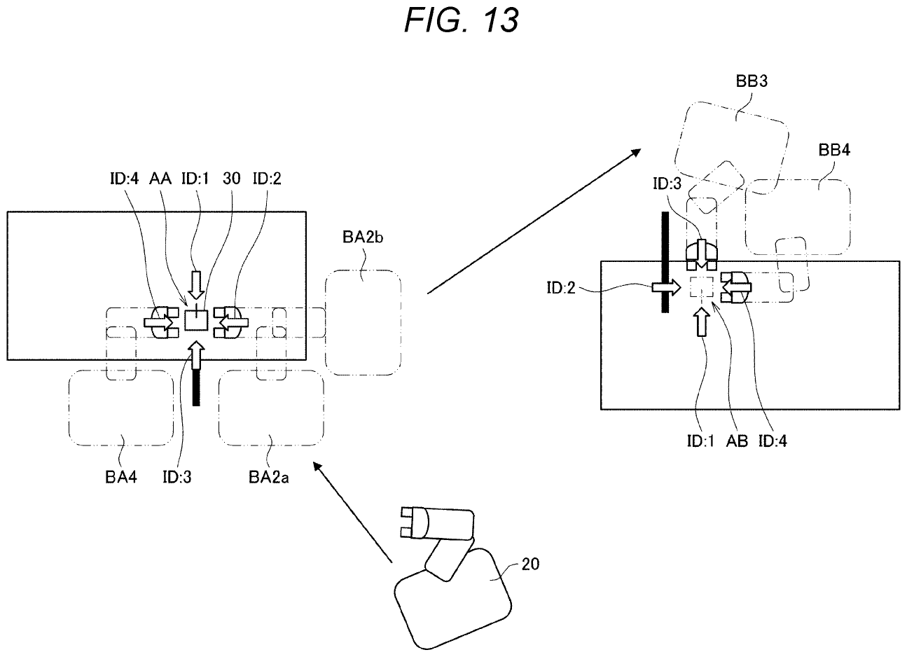

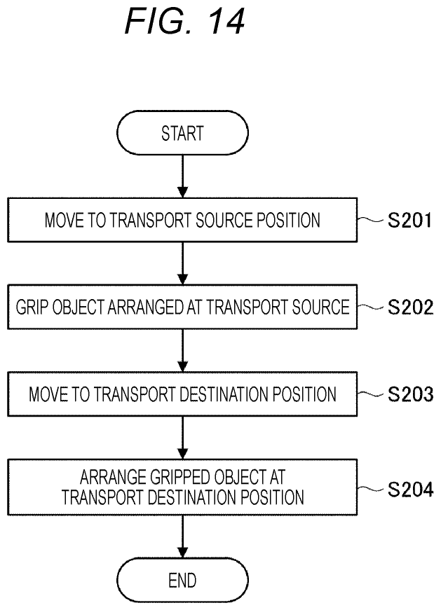

Next, an example of operation of the control apparatus 200 that controls the mobile object 20 according to the present embodiment will be described with reference to FIGS. 13 and 14. FIG. 13 is a schematic diagram illustrating an example of a transport operation of the mobile object 20. FIG. 14 is a flowchart illustrating a flow of the operation of the mobile object 20 when executing the work.

In the second embodiment, as in the first embodiment, first, the work execution unit 211 selects a work sequence to be executed from the work instruction data stored in the work instruction storage unit 251, and transmits the selected work sequence to the gripping position determination unit 213. A determination as to a gripping position in a case where the work of the sequence 0 in the work instruction data illustrated in FIG. 4 is executed will be described with reference to FIG. 14.

The gripping position determination unit 213 determines the gripping position of the object 30 by the hand portion 22 and the machine body position of the mobile object 20 corresponding to the gripping position on the basis of the received work sequence.

First, the gripping position determination unit 213 checks gripping positions by the hand portion 12 available at the transport source position on the basis of the object arrangement condition information. For example, in the object arrangement condition information illustrated in FIG. 12, in a case where the object 30 of “product X” is arranged at position AA as the transport source position, the available gripping positions are ID: 2 and 4. At the gripping position of ID: 2, there are two machine body positions BA2a and BA2b of the mobile object 20, and at the gripping position of ID: 4, there is one machine body position BA4 of the mobile object 20.

Next, the gripping position determination unit 213 checks gripping positions by the hand portion 22 available at the transport destination position on the basis of the object arrangement condition information. For example, in the object arrangement condition information illustrated in FIG. 12, in a case where the object 30 of “product X” is arranged at position AB as the transport destination position, the available gripping positions are ID: 3 and 4. At the gripping position of ID: 3, there is one machine body position BB3 of the mobile object 20, and at the gripping position of ID: 4, there is one machine body position BB4 of the mobile object 20.

Subsequently, the gripping position determination unit 213 extracts, as gripping position candidates available for the transport, gripping positions by the hand portion 22 available at both position AA as the transport source position and position AB as the transport destination position. In the object arrangement condition information illustrated in FIG. 12, since the gripping positions available at position AA are ID: 2 and 4, and the gripping positions available at position AB are ID: 3 and 4, ID: 4 is extracted as a gripping position candidate available for the transport.

Note that the gripping position determination unit 213 may further limit the available gripping positions by determining interference between the positions and postures of the manipulator 23 and the mobile object 20 at the available gripping positions obtained from the object arrangement condition information and obstacles existing in the surrounding environment of the object 30. As the obstacles existing in the surrounding environment of the object 30, for example, obstacles existing in the obstacle map stored in the obstacle information storage unit 254 may be used, or obstacles recognized in an image captured by the imaging device 411 or a result of sensing performed by the sensor 412 may be used. Alternatively, the gripping position determination unit 213 may determine interference only with respect to a new obstacle, which is a difference between the obstacle map created by the map creation unit 214 and the obstacle map stored in advance.

Next, the gripping position determination unit 213 causes the trajectory planning unit 215 to generate a trajectory plan of the hand portion 22 and causes the route planning unit 222 to generate a route plan of the mobile object 20 using the extracted gripping position candidate.

In a case where there is a plurality of gripping position candidates, on the other hand, the gripping position determination unit 213 generates a candidate list in which the gripping position candidates are arranged in descending order of a score derived on the basis of the amount of change of the manipulator 23 from the transport source position to the transport destination position. As a result, the gripping position determination unit 213 can cause the trajectory planning unit 215 to generate the trajectory plan of the hand portion 22 using the gripping position candidate having the best score in the generated candidate list. As described above, the sum of squares of amounts of movement of the joints of the arm portion 11 when the hand portion 12 is moved from the transport source position to the transport destination position may be used as the score, or the distance of the hand portion 12 from the transport source position to the transport destination position in the three-dimensional space or the amount of change of the three-dimensional posture may be used.

Subsequently, the gripping position determination unit 213 determines whether or not the trajectory plan has been successfully generated. If the generation of the trajectory plan fails due to interference with an obstacle, a movable range of the manipulator 23, or the like, the gripping position determination unit 213 deletes, from the candidate list, the gripping position candidate with which the generation of the trajectory plan has failed. Moreover, the gripping position determination unit 213 causes the trajectory planning unit 215 to generate the trajectory plan of the hand portion 22 again using a gripping position candidate having a next best score in the candidate list.

If the trajectory plan has been successfully generated, on the other hand, the gripping position determination unit 213 determines the gripping position candidate with which the trajectory plan has been successfully generated as the gripping position by the hand portion 22 to be used to transport the object 30.

Thereafter, the route planning unit 222 generates a route plan for transporting the object 30 from the current position of the mobile object 20 to the transport destination position via the transport source position using the gripping position by the hand portion 22 determined by the gripping position determination unit 213 to be used for the transport.

In a case where the trajectory plan of the hand portion 22 and the route plan of the mobile object 20 are generated, the work execution unit 211 causes the mobile object 20 to start transporting the object 30.

As illustrated in FIG. 14, first, the work execution unit 211 moves the mobile object 20 to the transport source position (S201). Specifically, the work execution unit 211 instructs the mobile object 20 to move by transmitting a planned route from the current position to the machine body position at the transport source position to the moving mechanism control unit 223 via the route planning unit 222. As a result, the moving mechanism control unit 223 can control the driving of the moving mechanism 25 such that the mobile object 20 follows the received route. In a case where the mobile object 20 reaches the machine body position at the transport source position, the moving mechanism control unit 223 notifies the work execution unit 211 of completion of the movement via the route planning unit 222.

Next, the work execution unit 211 causes the hand portion 22 to grip the object 30 arranged at the transport source position (S202). Specifically, the work execution unit 211 instructs, via the trajectory planning unit 215, the manipulator control unit 216 to grip the object 30 by transmitting the planned trajectory up to the gripping position of the object 30. As a result, the manipulator control unit 216 can control the driving of the manipulator 23 such that the hand portion 22 follows the received trajectory. In a case where the hand portion 22 reaches the gripping position of the object 30 and the gripping of the object 30 is completed, the manipulator control unit 216 notifies the work execution unit 211 of completion of the gripping via the trajectory planning unit 215.

The trajectory planning unit 215, however, may generate a trajectory plan of the hand portion 22 again using a result of sensing of a position and a posture of the object 30 in consideration of positional deviation and the like when the mobile object 20 reaches the machine body position at the transport source position. As the gripping position by the hand portion 22 at this time, the gripping position candidate used in the previous trajectory plan may be used.

Note that in a case where the hand portion 22 grips the object 30, the work execution unit 211 may instruct, via the trajectory planning unit 215, the manipulator control unit 216 to control the manipulator 23 in such a way as to achieve a transport posture.

Subsequently, the work execution unit 211 moves the mobile object 20 to the transport destination position while gripping the object 30 (S203). Specifically, the work execution unit 211 instructs the moving mechanism control unit 223 to move the mobile object 20 by transmitting the planned route from the machine body position at the transport source position to the machine body position at the transport source position via the route planning unit 222. As a result, the moving mechanism control unit 223 can control the driving of the moving mechanism 25 such that the mobile object 20 follows the received route. In a case where the mobile object 20 reaches the machine body position at the transport destination position, the moving mechanism control unit 223 notifies the work execution unit 211 of completion of the movement via the route planning unit 222.

Thereafter, the work execution unit 211 arranges the object 30 gripped by the hand portion 22 at the transport destination position (S204). Specifically, the work execution unit 211 instructs the manipulator control unit 216 to arrange the object 30 at the transport destination position by transmitting, via the trajectory planning unit 215, a planned trajectory up to a gripping position corresponding to the transport destination position of the object 30. As a result, the manipulator control unit 216 can control the driving of the manipulator 23 such that the hand portion 22 follows the received trajectory. In a case where the hand portion 22 reaches the gripping position of the object 30 and the gripping of the object 30 is completed, the manipulator control unit 216 notifies the work execution unit 211 of completion of arrangement of the object 30 via the trajectory planning unit 215.

The trajectory planning unit 215, however, may generate a trajectory plan of the hand portion 22 again using a result of sensing of the surrounding environment of the transport destination position in consideration of positional deviation and the like when the mobile object 20 reaches the machine body position at the transport destination position. As the gripping position by the hand portion 22 at this time, the gripping position candidate currently used to grip the object 30 may be used.

Note that in a case where the object 30 is arranged at the transport destination position by the hand portion 22, the work execution unit 211 may instruct, via the trajectory planning unit 215, the manipulator control unit 216 to control the manipulator 23 in such a way as to achieve a transport posture.

With the above operation, the control apparatus 200 can cause the mobile object 20 to transport the object 30 from the transport source position to the transport destination position on the basis of the work instruction data.

The preferred embodiments of the present disclosure have been described above in detail with reference to the accompanying drawings, but the technical scope of the present disclosure is not limited to such examples. It is obvious that those with ordinary skill in the technical field of the present disclosure can conceive various alterations or corrections within the scope of the technical idea recited in the claims, and it is naturally understood that these alterations or corrections also fall within the technical scope of the present disclosure.

Furthermore, the effects described in the present specification are merely exemplary or illustrative, and not restrictive. That is, the technology according to the present disclosure can exhibit other effects apparent to those skilled in the art from the description of the present specification, in addition to the effects described above or instead of the effects described above.

Note that the following configurations also fall within the technological scope of the present disclosure.

(1)

A control apparatus including:
a storage unit that stores object arrangement condition information in which gripping positions of an object available when a manipulator grips the object are set in advance in correspondence with a type of object and a position where the object is arranged; and
a gripping position determination unit that determines, when the manipulator transports the object from a transport source position to a transport destination position, a gripping position of the object by the manipulator on the basis of gripping positions of the object set in the object arrangement condition information for the transport source position and gripping positions of the object set in the object arrangement condition information for the transport destination position.
   (2)

The control apparatus according to (1), in which
the gripping position determination unit determines a gripping position available at both the transport source position and the transport destination position as a gripping position candidate to be used for the transport.
   (3)

The control apparatus according to (2), in which
in a case where there is a plurality of the gripping position candidates, the gripping position determination unit generates a candidate list in which the gripping position candidates are arranged in score order using a score based on an amount of change of the manipulator from the transport source position to the transport destination position.
   (4)

The control apparatus according to (3), further including:
a trajectory planning unit that generates trajectory plans of the manipulator, in which the trajectory planning unit sequentially generates the trajectory plans using the gripping position candidates in order of the score in the candidate list.
   (5)

The control apparatus according to (4), in which
the gripping position determination unit deletes, from the candidate list, the gripping position candidate with which generation of the trajectory plan has failed, and determines the gripping position candidate with which the trajectory plan has been successfully generated as the gripping position of the object by the manipulator.
   (6)

The control apparatus according to (5), in which
the gripping position determination unit deletes, from the candidate list on the basis of a result of sensing of a surrounding environment of the object, the gripping position candidate with which the sensed surrounding environment and the manipulator interfere with each other.
   (7)

The control apparatus according to (6), in which
the gripping position determination unit determines whether or not a difference between an environment map indicating the surrounding environment of the object created in advance and the result of the sensing of the surrounding environment of the object interferes with the manipulator.
   (8)

The control apparatus according to (6), in which
the manipulator is mounted on a mobile object.
   (9)

The control apparatus according to (8), in which
in the object arrangement condition information, the gripping positions of the object available when the manipulator grips the object are set in further correspondence with a machine body position of the mobile object.
   (10)

The control apparatus according to (8) or (9), in which
the gripping position determination unit generates the candidate list using the score further based on an amount of change of the mobile object from the transport source position to the transport destination position.
(11)

The control apparatus according to any one of (8) to (10), in which
the gripping position determination unit further deletes, from the candidate list, the gripping position candidate with which the sensed surrounding environment and the mobile object interfere with each other.
   (12)

The control apparatus according to (11), in which
the gripping position determination unit determines whether or not a difference between an environment map indicating the surrounding environment of the object created in advance and the result of the sensing of the surrounding environment of the object interferes with the mobile object.
   (13)

A control method including:
by an arithmetic processing device,
preparing object arrangement condition information in which gripping positions of an object available when a manipulator grips the object are set in advance in correspondence with a type of object and a position where the object is arranged; and
determining, when the manipulator transports the object from a transport source position to a transport destination position, a gripping position of the object by the manipulator on the basis of gripping positions of the object set in the object arrangement condition information for the transport source position and gripping positions of the object set in the object arrangement condition information for the transport destination position.

### REFERENCE SIGNS LIST

10 Manipulator apparatus
11, 21 Arm portion
12, 22 Hand portion
20 Mobile object
23 Manipulator
25 Moving mechanism
30 Object
41 Imaging device
100, 200 Control apparatus
111, 211 Work execution unit
112, 212 Object recognition unit
113, 213 Gripping position determination unit
114, 214 Map creation unit
115, 215 Trajectory planning unit
116 Control unit
151, 251 Work instruction storage unit
152, 252 Gripping position storage unit
153, 253 Object arrangement condition storage unit
154, 254 Obstacle information storage unit
216 Manipulator control unit
221 Self-position estimation unit
222 Route planning portion
223 Moving mechanism control unit
411 Imaging device
412 Sensor

What is claimed is:

1. A control apparatus comprising:
a storage unit that stores object arrangement condition information in which gripping positions of an object available when a manipulator grips the object are set in advance in correspondence with a type of object and a position where the object is arranged; and
a gripping position determination unit that determines, when the manipulator transports the object from a transport source position to a transport destination position, a gripping position of the object by the manipulator on a basis of gripping positions of the object set in the object arrangement condition information for the transport source position and gripping positions of the object set in the object arrangement condition information for the transport destination position.

2. The control apparatus according to claim 1, wherein
the gripping position determination unit determines a gripping position available at both the transport source position and the transport destination position as a gripping position candidate to be used for the transport.

3. The control apparatus according to claim 2, wherein
in a case where there is a plurality of the gripping position candidates, the gripping position determination unit generates a candidate list in which the gripping position candidates are arranged in score order using a score based on an amount of change of the manipulator from the transport source position to the transport destination position.

4. The control apparatus according to claim 3, further comprising:
a trajectory planning unit that generates trajectory plans of the manipulator, wherein
the trajectory planning unit sequentially generates the trajectory plans using the gripping position candidates in order of the score in the candidate list.

5. The control apparatus according to claim 4, wherein
the gripping position determination unit deletes, from the candidate list, the gripping position candidate with which generation of the trajectory plan has failed, and determines the gripping position candidate with which the trajectory plan has been successfully generated as the gripping position of the object by the manipulator.

6. The control apparatus according to claim 5, wherein
the gripping position determination unit deletes, from the candidate list on a basis of a result of sensing of a surrounding environment of the object, the gripping position candidate with which the sensed surrounding environment and the manipulator interfere with each other.

7. The control apparatus according to claim 6, wherein
the gripping position determination unit determines whether or not a difference between an environment map indicating the surrounding environment of the object created in advance and the result of the sensing of the surrounding environment of the object interferes with the manipulator.

8. The control apparatus according to claim 6, wherein
the manipulator is mounted on a mobile object.

9. The control apparatus according to claim 8, wherein
in the object arrangement condition information, the gripping positions of the object available when the manipulator grips the object are set in further correspondence with a machine body position of the mobile object.

10. The control apparatus according to claim 8, wherein
the gripping position determination unit generates the candidate list using the score further based on an amount of change of the mobile object from the transport source position to the transport destination position.

11. The control apparatus according to claim 8, wherein
the gripping position determination unit further deletes, from the candidate list, the gripping position candidate with which the sensed surrounding environment and the mobile object interfere with each other.

12. The control apparatus according to claim 11, wherein
the gripping position determination unit determines whether or not a difference between an environment map indicating the surrounding environment of the object created in advance and the result of the sensing of the surrounding environment of the object interferes with the mobile object.

13. A control method comprising:
by an arithmetic processing device,
preparing object arrangement condition information in which gripping positions of an object available when a manipulator grips the object are set in advance in correspondence with a type of object and a position where the object is arranged; and
determining, when the manipulator transports the object from a transport source position to a transport destination position, a gripping position of the object by the manipulator on a basis of gripping positions of the object set in the object arrangement condition information for the transport source position and gripping positions of the object set in the object arrangement condition information for the transport destination position.
